(19) United States
(12) Patent Application Publication
(10) Pub. No.: US 2007/0272826 A1
(43) Pub. Date: Nov. 29, 2007

(54) Solar tracker stand

(75) Inventors: Cheng-Chao Huang, Fonglin Township (TW); Cheng-Dar Lee, Tainan City (TW); Ming-Huei Chen, Taoyuan City (TW); Yen-Chang Tzeng, Yonghe City (TW)

Correspondence Address: TROXELL LAW OFFICE PLLC, SUITE 3404, 5205 LEESBURG PIKE, FALLS CHURCH, VA, 22041, US

(73) Assignee: Atomic Energy Council-Institute of Nuclear Energy Research

(21) Appl. No.: 11/440,423

(22) Filed: May 25, 2006

(51) Int. Cl. G01J 1/20

(52) U.S. Cl. 250/203.4

(57) ABSTRACT

A stand for a solar tracker firmly holds the solar tracker and is movable for easy positioning. Hence, when a place for setting a base for the stand is hard to obtain, a pillar does not need to be constructed to fix the solar tracker.

### FIELD OF THE INVENTION

The present invention relates to a stand; more particularly, relates to combining a frame and a hollow cylinder to fix a solar tracker on the stand easily, firmly and movably, where the frame has a plurality of curved feet and so a pillar are saved from constructing at place a base of the stand is hard to obtain.

### DESCRIPTION OF THE RELATED ART

A general stand for a solar tracker, as shown in FIG. 4, has a pillar 41; the pillar 41 is fixed on a base 42; the pillar 41 is a hollow cylinder; and, an inserting shaft 44 at a bottom of a solar tracker and a solar cell module 43 is inserted into the pillar 41 from top. Although the stand can hold the solar tracker and the solar cell module 43, the pillar 41 is fixed on the base 42 and so is not movable. Besides, to construct the pillar 41 on the base 42, it takes time and cost. Hence, the prior art does not fulfill users' requests on actual use.

### SUMMARY OF THE INVENTION

The main purpose of the present invention is to provide a stand for a solar tracker, where, by combining a hollow cylinder and a frame having a supporting part of a plurality of curved feet, a solar tracker is firmly fix at the stand and is easily positioned with movability; a structure is strengthened; and, so, a pillar can be saved from constructing at place a base is hard to obtain.

To achieve the above purpose, the present invention is a solar tracker stand, comprising a frame and a hollow cylinder, where the frame has a supporting part; the supporting part is formed by combining a plurality of curved feet for firmly establishing and positioning the stand; the hollow cylinder is combined with the frame; and, so, a solar tracker and a solar cell module is fix at the stand and the stand is firmly established and easily positioned with a strengthened structure. Accordingly, a novel solar tracker stand is obtained.

### BRIEF DESCRIPTIONS OF THE DRAWINGS

The present invention will be better understood from the following detailed descriptions of the preferred embodiments according to the present invention, taken in conjunction with the accompanying drawings, in which

FIG. 1 is a perspective view showing the first preferred embodiment according to the present invention;

FIG. 2 is a perspective view showing the second preferred embodiment;

FIG. 3 is a perspective view showing the third preferred embodiment; and

FIG. 4 is a view of a prior art.

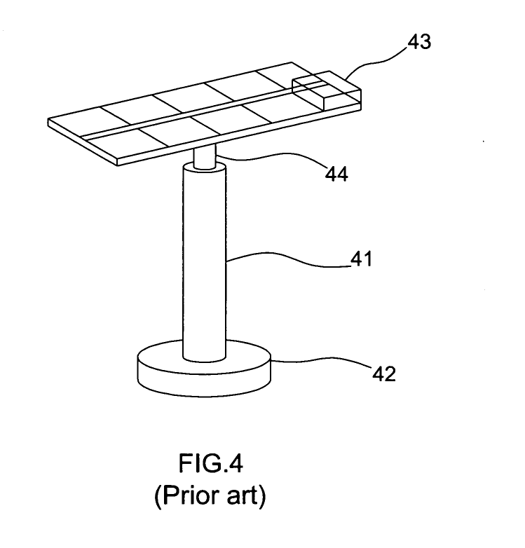

### DESCRIPTION OF THE PREFERRED EMBODIMENTS

The following descriptions of the preferred embodiments are provided to understand the features and the structures of the present invention.

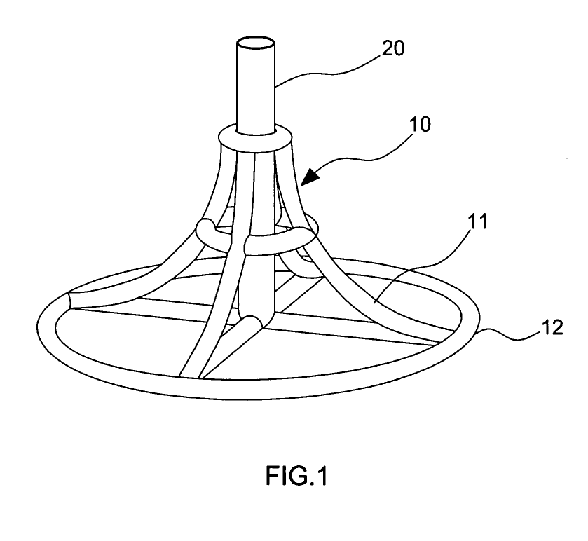

Please refer to FIG. 1 to FIG. 3, which are perspective views showing the first, the second and the third preferred embodiments according to the present invention. As shown in the figures, the present invention is a solar tracker stand, comprising a frame 10 and a hollow cylinder 20, where the frame 10 is constructed with a supporting part to establish and position the solar tracker stand; the supporting part of the frame 10 is formed by combining a plurality of curved feet 11 or combining the plurality of curved feet 11 to a circling pipe 12; the hollow cylinder 20 is combined with the frame 10; the hollow cylinder is penetrated into to be fixed with the frame 10, or is fixed upon the frame; and, so, a solar tracker is fixed firmly on the stand. Thus, a novel solar tracker stand is obtained.

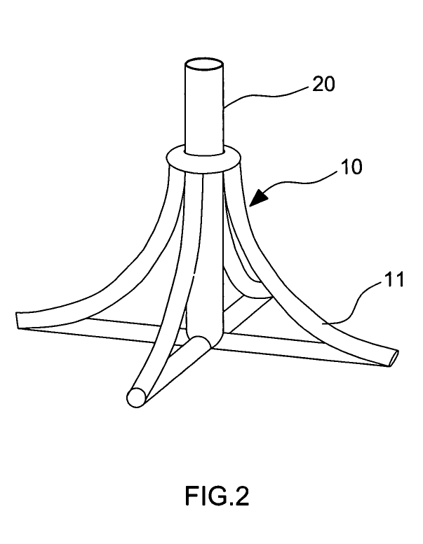

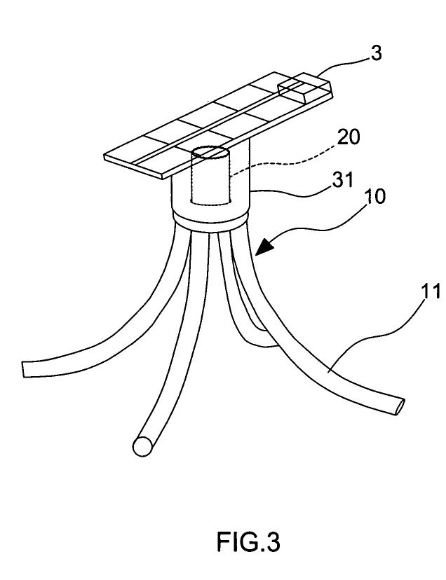

The hollow cylinder 20 is combined with the frame 10 by penetrating into the frame 10, or being fixed upon the frame 10, to firmly bind the frame 10 and the hollow cylinder 20 so that a solar tracker can be fix at the stand. Besides, a plurality of curved feet 11 (as shown in FIG. 2) are combined together, or are combined to at least one circling pipe, to form a supporting part of the frame 10 (as shown in FIG. 1). Thus, a solar tracker and solar cell module is firmly fixed at the solar tracker stand with the frame 10 so that the whole structure is strengthened and is movable. When using the present invention (as shown in FIG. 3), all what is required is to insert an inserting shaft 31 at the bottom of the solar tracker into the hollow cylinder 20. Consequently, the present invention can be obtained with strengthened structure; be firmly positioned; be easily moved; and, so, a pillar does not need to be constructed where a base is hard to obtain.

The preferred embodiments herein disclosed are not intended to unnecessarily limit the scope of the invention. Therefore, simple modifications or variations belonging to the equivalent of the scope of the claims and the instructions disclosed herein for a patent are all within the scope of the present invention.

What is claimed is:

1. A solar tracker stand, comprising:
a frame, said frame having a supporting part, said supporting part obtained by binding a plurality of curved feet to support said stand;
a hollow cylinder, said hollow cylinder being combined with said frame,
wherein said stand is positioned and moved with a solar tracker and a solar cell module fixed at said stand.

2. The solar tracker stand according to claim 1,
wherein said plurality of curved feet of said supporting part is combined to at least one circling pipe.

3. The solar tracker stand according to claim 1,
wherein said hollow cylinder is penetrated into and fixed with said frame.

4. The solar tracker stand according to claim 1,
wherein said hollow cylinder is fixed upon said frame.
